(19) United States
(12) Patent Application Publication
(10) Pub. No.: US 2004/0002951 A1
(43) Pub. Date: Jan. 1, 2004

(54) System and method for automatically processing states of a plurality of information platforms

(76) Inventors: Jeng-Yi Wu, Hsinchu (TW); Yen-Hua Chen, Taipei (TW); Hsiao-Hung Chin, Hsinchu (TW)

Correspondence Address: SHAW PITTMAN LLP, 1650 TYSONS BOULEVARD, MCLEAN, VA, 22102, US

(21) Appl. No.: 10/428,112

(22) Filed: May 2, 2003

(30) Foreign Application Priority Data
Jun. 28, 2002 (TW) 91114394

(51) Int. Cl. G06F 17/30

(52) U.S. Cl. 707/1

(57) ABSTRACT

The present invention provides a system and a method for automatically processing a plurality of information platform states, such as servers, network device and database. Each information platform respectively has at least one state file. The state file records the states of the information platform in a unified format. The state files are received from information platforms through a single transmission protocol and analyzed to determine whether a notification should be sent to a receiver. An electronic notification then is transmitted to the receiver. The present invention also provides a unified interface for presenting information. The present invention reduces managing complexity and costs, and increases productivity.

This Application claims priority to Taiwan Patent Application No. 091114394 filed on Jun. 28, 2002.

### FIELD OF INVENTION

The present invention relates to a system and method for automatically processing states of a plurality of information platforms and more particularly, relates to a automatically processing system and method for transmitting state files from a plurality of information platforms, such as server, network device and database, by using a single transfer protocol.

### BACKGROUND OF THE INVENTION

With the progress of technology and the wide use of network technology, enterprises can make use of various information systems to improve efficiency and integrate internal information within the enterprise.

When an enterprise has several departments very much diverse in their business scope, different departments usually have their own independent information systems. Yet the conventional information systems designed for the use of accounting or human resources departments have become insufficient for the integration of enterprise resources. Hence software manufacturers integrate softwares for manufacturing, sale, marketing, storage, and product development to create various application software systems such as Enterprise Resource Planning (ERP), Customer Relationship Management (CRM), and Supply Chain Management (SCM).

However, these systems, which can strengthen market competence, decrease costs and increase efficiency, involve many different operation systems, hardware platforms, databases and application platforms. If the information flows cannot be exchanged and transmitted among each distinct platform, they can not be integrated for users to further analyze existing problems so as to provide solutions and management strategy. Typically, different platform systems are highly independent thus preventing horizontal integration of information flows.

The information integration at the back end of the information systems can not only bring a centralized-management mechanism for the corporation, but respond to the demand for simplifying proceedings and enhancing efficiency. The enterprise information integration is a component even more crucial to the development of business between enterprises and of electronic commerce.

### SUMMARY OF THE INVENTION

An object of the present invention is to provide a system and a method for automatically processing states of a plurality of information platforms such as server, network device and database thus reducing management complexity and costs and preventing man-made mistakes.

The present invention provides a system for automatically processing a plurality of information platform states. Each information platform has at least a state file recording the state of the information platform in a unified format. The plurality of information platforms have a single transfer protocol for transmitting the state files. The system includes a receiving unit, a determination unit and a transmission unit. The receiving Unit receives the state files from a plurality of information platforms through a single transfer protocol. The determination unit analyzes the state files to determine whether there are situations that should be notified of and, if yes, the data and contact information of a receiver are obtained from the state file. Then the transmission unit transmits a notice to the respective receiver by sending an electronic message.

The present invention further provides a method for automatically processing states of a plurality of information platforms. First, the state file is received from a plurality of information platforms through a single transfer protocol. Then the state file is analyzed to determine whether there are situations that should be notified of and, if yes, the data and contact information of a receiver are obtained from the state file. Additionally, a notice is transmitted to the respective receiver by sending an electronic message.

### BRIEF DESCRIPTION OF THE DRAWINGS

FIG. 1 discloses an embodiment of the present invention;

FIG. 2 discloses a structure of an information platform;

FIG. 3 discloses an example of directory tree under Windows operation system;

FIGS. 4(a), (b), (c) discloses a state file of the information platform being recorded in a unified format and transmitted through File Transfer Protocol (FTP) in accordance with the present invention;

FIG. 5 discloses a state file being received from a plurality of information platforms through a single transfer protocol in accordance with the present invention;

FIG. 6 discloses a system for automatically processing states of a plurality of information platforms in accordance with the present invention;

FIG. 7 discloses an interaction interface in accordance with the present invention;

FIG. 8 discloses a flow chart of a method for automatically processing states of a plurality of information platforms in accordance with the present invention;

FIG. 9 discloses another embodiment in accordance with the present invention.

### DETAILED DESCRIPTION

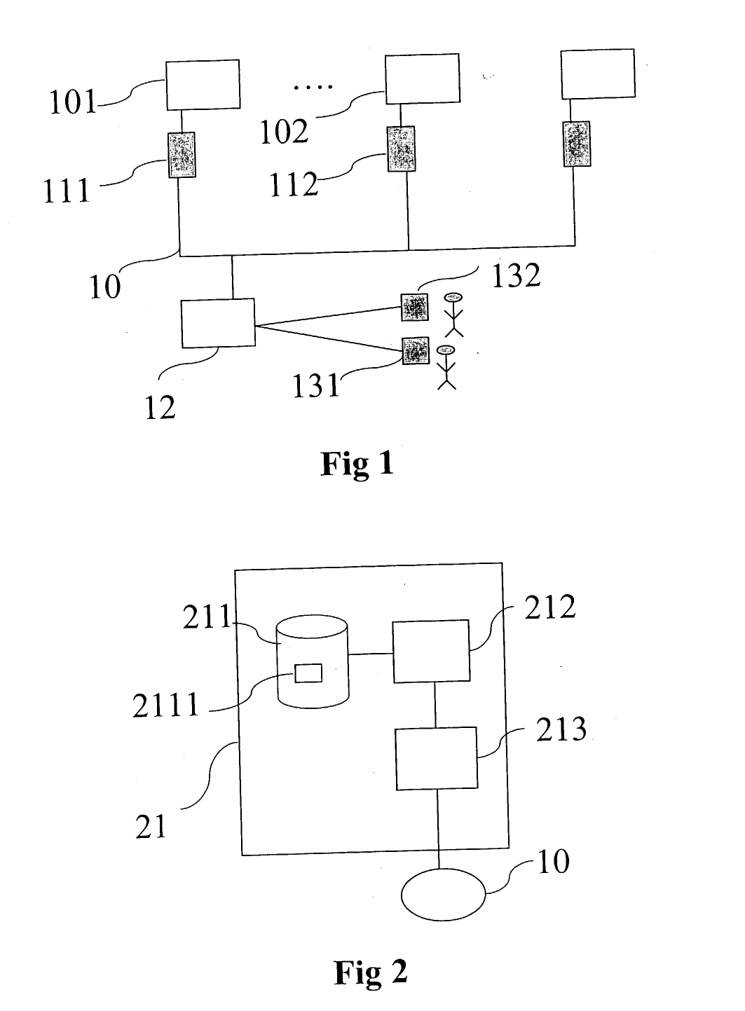

FIG. 1 shows a preferred embodiment for use within an enterprise. The enterprise has multi-departments such as 101 and 102. Each department is in charge of an information platform such as 111 and 112. The multi-information platforms exchange information flows through a network device 10 and are connected via the network device 10 to a system 12 for automatically processing states of information platforms. User ends 131 and 132 obtain the state of respective information platforms from the system 12. Typically, the information platforms include servers, network devices and databases. Servers provide services such as databases, network management and centralized file storage for the network users, and provide management function for network administrators. Partial functions of the information platforms include: storing various operation system modules and shared programs and instructions, storing users' programs and data, managing document systems, managing security and user log-in, supervising network, managing components, and providing data protection, such as Un-Interrupt Power Supply (UPS) and backups.

The enterprise having multi-departments interconnects each department by constructing inner networks, such as Intranet. That means users, via the Internet network, share the CPUs built in the department information platforms to meet the demand of the system for high-speed computing. Intranet, the enterprise inner network, applies the technique of the Internet network, so that the staff can share, communicate and transmit information at the smallest cost of money, time and manpower and increase efficiency and competence. Intranet consists mainly of network, E-mail, enterprise inner network, mailing lists, and FTP.

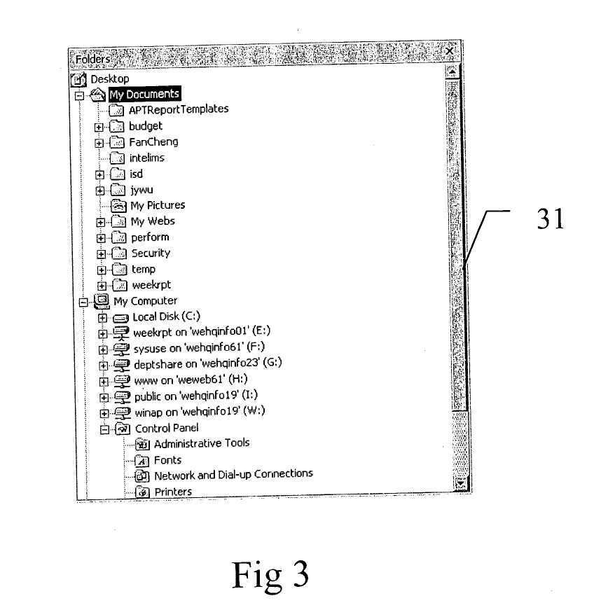

FIG. 2 shows a server 21 having a storage unit 211, a processing unit 212 and an input/output unit 213. The storage unit 211 stores at least a state file for recording the state of the information platform. The processing unit 212 processes data in the storage unit 211. The input/output unit 213 is connected to network 10. However, under different operation platforms, directories are formed differently. FIG. 3 discloses a directory form 31 in the Windows operation system.

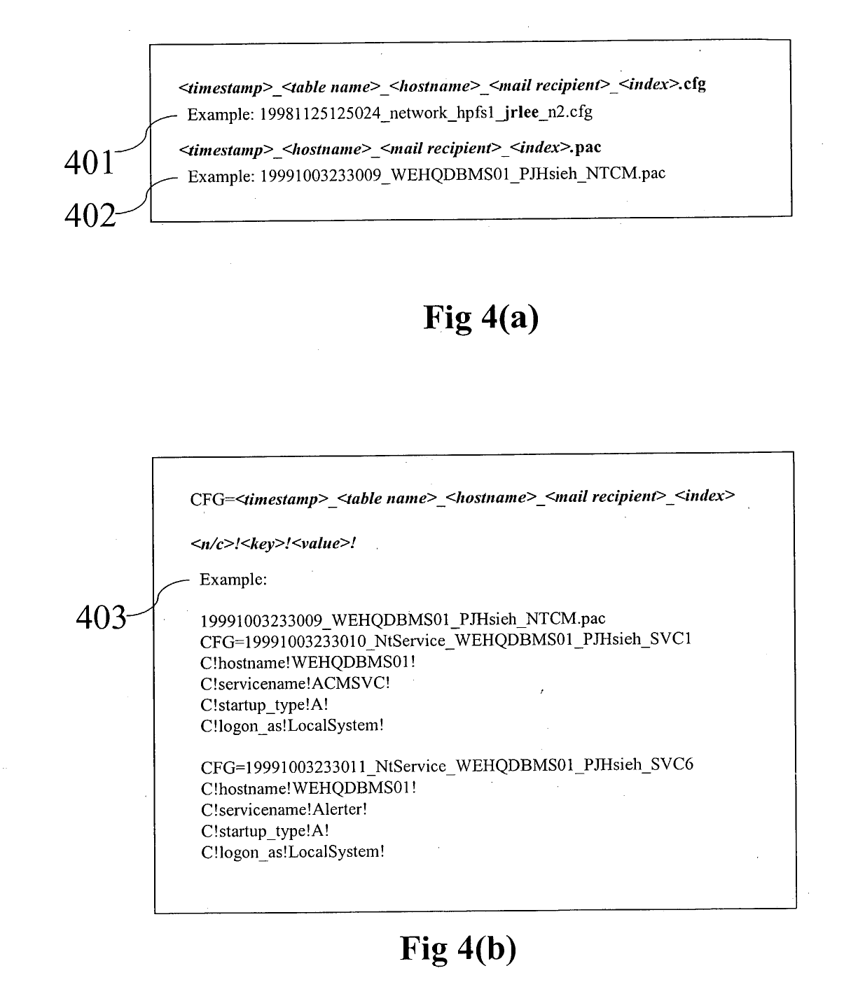

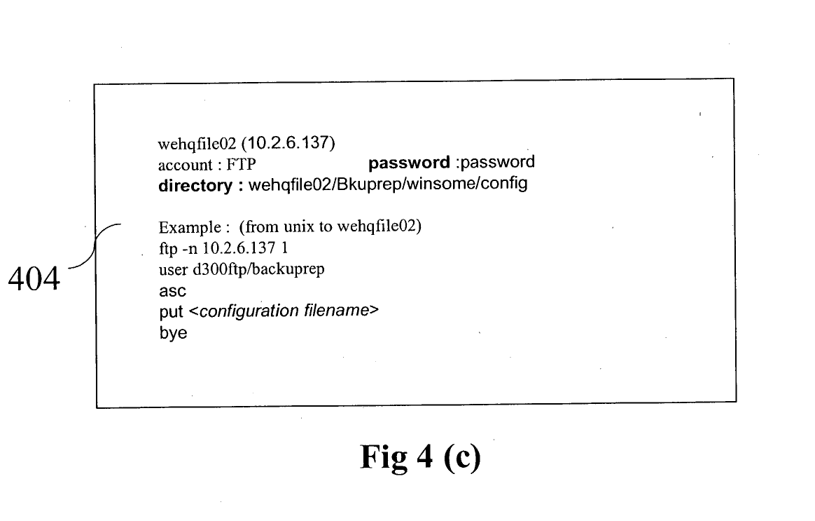

FIGS. 4(a), 4(b), and 4(c) disclose a state file of one of the information platforms being recorded in a unified format and transmitted via FTP. FIG. 4(a) shows an example of a unified file naming. A single record file is recorded as a .cfg file, while a multi-record file is recorded as a .pac file. The unified format includes a plurality of variables, wherein:

<timestamp> is a time stamp consisting of 14 bits to denote year, month, date, hour, minute, and second in the format of yyyymmddHHMMSS;

<table name> is a directory name;

<hostname> is a host name;

<mail recipient> is the owner's mail address; and

<index> is an index established by the user.

Example 401 shows a single record file name in which the time stamp is 12:50:24 p.m. Nov. 25, 1998, the directory name is network, the host name is hpfs1, the owner's mail address is jrlee, and the index is n2. Example 402 shows a multi-record file name in which the time stamp is 11:30:09 p.m. Oct. 3, 1999, the host name is WEHQDBMS01, the owner's mail address is PJHsieh, and the index is NTCM.

FIG. 4(b) shows a unified file format, wherein:

<n/c> is a number or a character;

<key> is an item name; and

<value> is an item value.

Example 403 in FIG. 4(b) shows a file format whose file name is 19991003233009_WEHQDBMS01_PJHsieh_NTCM.pac. The time stamp of the file format is 11:30:10 p.m. Oct. 3, 1999. The directory name is NtService. The host name is WEHQDBMS01. The owner's mail address is PJHsieh. The index is SVC1. The item name recorded in a character “C” is hostname and the item value is WEHQDBMS01. The item name recorded in a character “C” is servicename and the item value is ACMSVC.

FIG. 4(c) shows that each user needs an account and a password while transmitting a state file to the information platforms via FTP. In example 404 of FIG. 4(c), a user transmits a file from a UNIX system to “wehqfile02” located in 10.2.6.137 via FTP after logging in an account “FTP” with a password “password”.

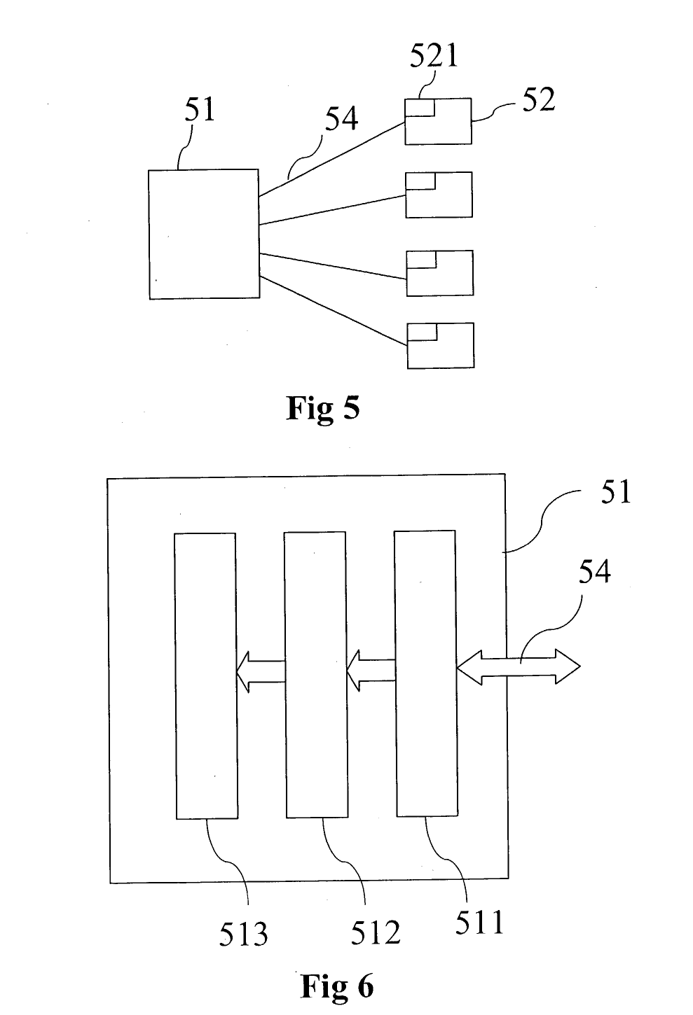

FIG. 5 shows a system 51 for automatically processing states of a plurality of information platforms receiving a file transmitted from the information platform 52 of different operation systems through a single transmission protocol 54, e.g. FTP. FTP is a set of common communication protocol standard for transmitting files between different operation systems within the Internet network. As long as an operation system follows this protocol, it is able to send files to and receive files from other different operation systems. FTP determines how a computer system, connected to another computer system through Internet, can access data over the Internet. The main task of the protocol is to provide a list of file directories to transmit and to exchange files. With FTP, files can be easily transmitted between any two information platforms whether they are the same operation system or not. Generally when accessing files via FTP, users need to log in an account and a password to transmit files in both directions.

As described above, the present invention provides a system for automatically processing states of a plurality of information platforms. The plurality of information platforms 52, such as servers, network devices and databases, being either different or same operation platforms, respectively has at least a state file recording the states of the corresponding information platform in a unified format. The plurality of information platforms have a single transmission protocol for transmitting the state files. As shown in FIG. 6, the system 51 includes a receiving unit 511, a determination unit 512 and a transmission unit 513. The receiving unit 511 receives the state files from the plurality of information platforms 52 through a single transfer protocol 54. When the receiving unit 511 receives the plurality of state files, the state files are compiled into another file or a database for analysis.

The states of the information platforms 52 in an embodiment of the present invention include a system fault state, a security control state, a system configuration state, a performance analysis state, and a resource maintenance state. The system fault state handles proactive and reactive actions of system fault, data backup process and disaster recovery procedure. The security control state manages the establishment of system security standards, the preventive action of Identification/Authentication/Certification, the corrective action of Tracking/Detecting/Monitoring, and the physical security. The system configuration state administers a system change and a configuration data repository. The performance analysis state manages system efficiency and performance index setting. The resource maintenance state administers management of physical and non-physical asset of the system.

The determination unit 512 of the system in accordance with the present invention analyzes the state file transmitted from the receiving unit 511 to determine whether a notification should be sent. If yes, for example, when the use of the system is under a threshold, or the system has been changed, the transmission unit 513 is notified of the data and contact information of receivers obtained from the state file. Then the transmission unit 513, by an electronic information transmission, such as e-mail, transmits the data to the receivers respectively.

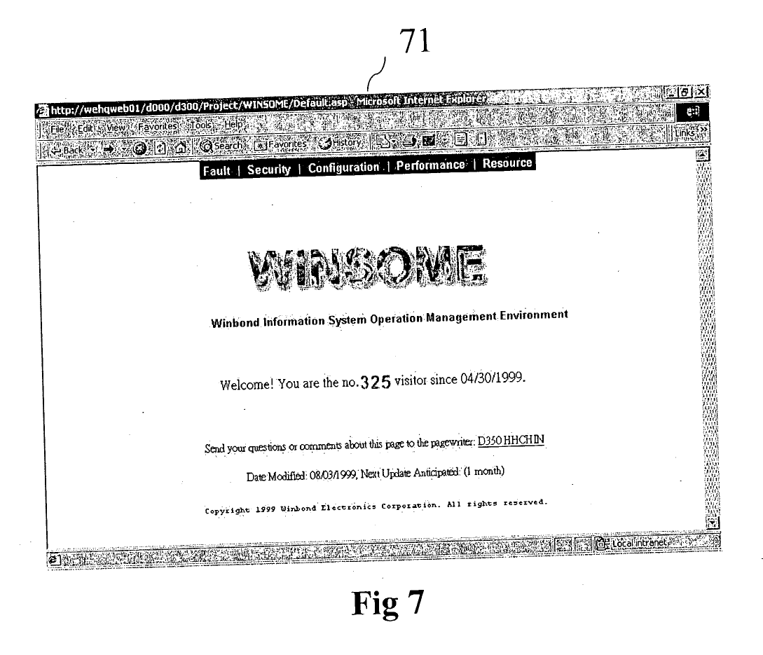

To facilitate management by the administrator, the system of the present invention further includes a unified interaction interface. With unified interaction interface the users can further process the contents of the collected state files. In the embodiment of the present invention, the interaction interface 71 is designed in the form of world wide web (WWW), as shown in FIG. 7, so that the users can utilize the interaction interface 71 by using a browser.

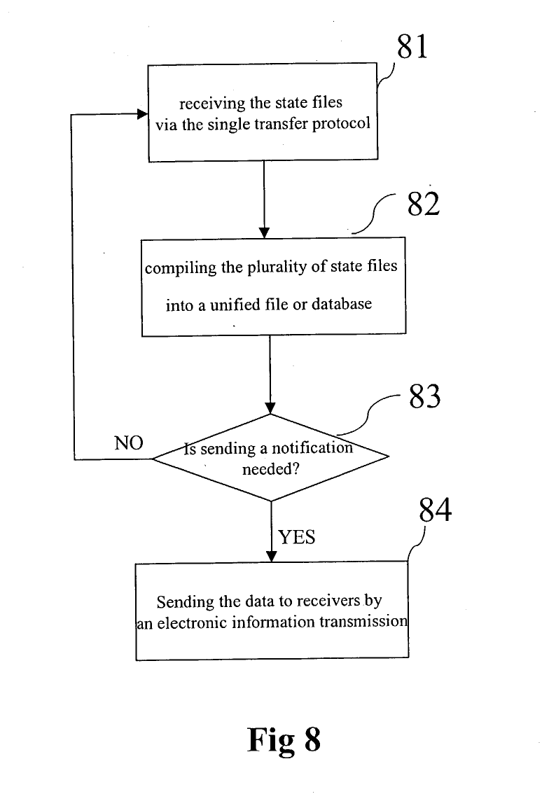

The present invention further provides a method for automatically processing states of a plurality of information platforms, referring to FIG. 8. The plurality of information platforms, such as servers, network devices and databases, has different or same operation platforms. Each information platform has at least a state file for recording the state of the information platform in a unified format. The plurality of information platforms have a single transfer protocol for transmitting the state file. First, the state files are received from the plurality of information platforms with different or same operation platforms via the single transfer protocol (Step 81) and the plurality of state files are compiled into a unified file or database (Step 82). Then the state files are analyzed to determine whether a notification should be sent (Step 83). For example, when the use of the system is under a threshold or the system has been changed, the data and contact information of receivers are obtained from the state files. In addition, by an electronic information transmission, such as e-mail, the notification data is transmitted to the respective receivers (Step 84).

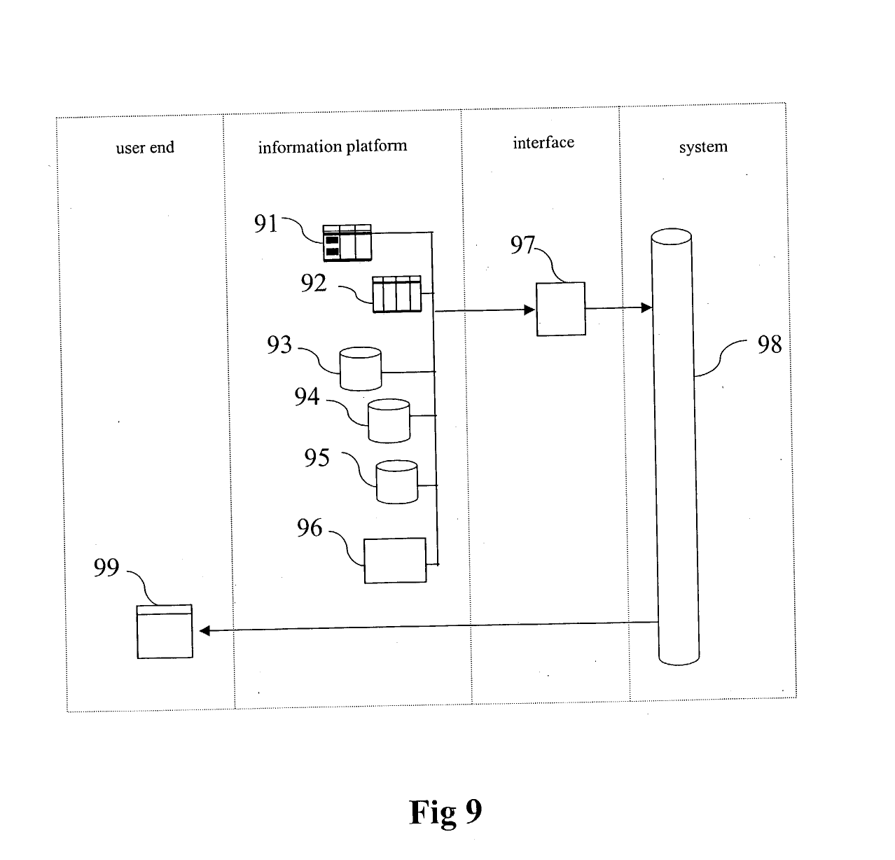

FIG. 9 discloses another embodiment of the present invention. In the embodiment, an enterprise has different information system platforms 91˜96, which may be different operation systems, such as VMS and UNIX, or may be different database systems such as Oracle, RDB, DBMS and SQL. Each information platform has at least a state file. The file state records various states in a unified format, such as a system fault state, a security control state, a system configuration state, a performance analysis state, and a resource maintenance state. These information platforms, through a single transfer protocol such as FTP 97, transmit the state files to the system 97 for automatically processing states information of information platforms. The system processes and analyzes the states of the respective information platforms to determine whether a notification should be sent. The system transmits the notification data needing transmission to the respective receivers by sending an electronic message. Further, the system summarizes the analyzed data in a report for the users. The system further provides an interaction interface 99 for presenting the collected state files and report to the user end. The users can process the states of the respective information platforms via the interaction interface 99.

The invention having been described above in terms of a preferred embodiment, it should be understood that the terminology used is intended to help understand the implement of the present invention rather than to limit. Those skilled in the art will recognize that the invention can be practiced with an equivalent modification within the spirit and scope of the present invention. Thus, the present invention in which an exclusive property or privilege is claimed is defined as the appended claims.

1. A system for automatically processing states of a plurality of information platforms, each information platform having at least one state file saved in a predetermined uniform format for recording the state of the information platform, the plurality of information platforms using a single transfer protocol for transmitting the state files, comprising:
a receiving unit for receiving the state files from the plurality of information platforms via the single transfer protocol;
a determination unit for analyzing and determining whether the state files respectively include data needing transmission and, if yes, for retrieving the data and contact information of receivers; and
a transmission unit for transmitting the data to the receivers electronically.

2. The system of claim 1, wherein the plurality of information platforms respectively selectively include different operation platforms.

3. The system of claim 1, wherein the transmission unit transmits the data to the receivers by email.

4. The system of claim 1, wherein the receiving unit receives the plurality of state files and compiles into another file or a database for analysis.

5. The system of claim 1, wherein the system further comprises an interaction interface for an administrator to browse contents of the state files.

6. The system of claim 5, wherein the interaction interface is designed according to specification of world wide web (WWW).

7. A method for automatically processing states of a plurality of information platforms, each information platform having a predetermined catalog for storing at least one state file, each state file recording the state of each information platform in a predetermined uniform format, the plurality of information platforms using a single transfer protocol for transmitting the state files, comprising:
receiving the state files from the plurality of information platforms via the single transfer protocol;
analyzing and determining whether the state files respectively include data needing transmission and, if yes, for retrieving the data and contact information of receivers; and
transmitting the data to the receivers electronically.

8. The method of claim 7, wherein the plurality of information platforms respectively selectively include different operation platforms.

9. The method of claim 7, wherein the data is transmitted to the receivers by email.

10. The method of claim 7, wherein the step of receiving the state files further comprises receiving the plurality of state files and compiling into another file or a database for analysis.

11. The method of claim 7, further providing an interaction interface for an administrator to browse contents of the state files.

12. The method of claim 11, wherein the interaction interface is designed according to specification of world wide web (WWW).
